(19) United States
(12) Patent Application Publication
(10) Pub. No.: US 2022/0269517 A1
(43) Pub. Date: Aug. 25, 2022

(54) ADAPTABLE WARNINGS AND FEEDBACK

(71) Applicant: Avaya Management L.P., Durham, NC (US)

(72) Inventors: Valentine C. Matula, Granville, OH (US); Harsimran Jeet Singh, Pune (IN); Jibin George, Pune (IN); Sandeep Goynar, Pune (IN)

(21) Appl. No.: 17/185,535

(22) Filed: Feb. 25, 2021

(51) Int. Cl. G06F 9/451; G06N 3/08; H04M 3/51; G06F 40/174

(52) U.S. Cl. CPC G06F 9/453; G06N 3/08; H04M 3/5141; G06F 40/174

(57) ABSTRACT

Co-browsing sessions between a customer and an agent are conducted in real-time and provide an opportunity for the customer to receive assistance or guidance from the agent while performing operations online, such as completing a web form. Systems monitor the inputs provided by the customer. If an error is detected, such as entering confidential information in a non-confidential field, the customer is warned and the agent may be blocked from seeing the data. However, this may be due to a mistake. As provided herein, if a customer tells the agent that the entry is correct a server may process the comment to the agent and automatically remove the warning, allow the customer to continue typing in the field, allow the agent to see the content provided, and/or automatically update the logic to reduce the chances of erroneous error detection in subsequent encounters with similar data.

### COPYRIGHT NOTICE

A portion of the disclosure of this patent document contains material that is subject to copyright protection. The copyright owner has not objected to the facsimile reproduction by anyone of the patent document or the patent disclosure as it appears in the Patent and Trademark Office patent files or records, but otherwise reserves all copyright rights whatsoever.

### FIELD OF THE DISCLOSURE

The invention relates generally to systems and methods for data validation and particularly to cross-channel correction of erroneous data.

### BACKGROUND

In prior art contact centers, omnichannel interaction between customers and agents are commonplace. Often these interactions involve the customer filling in a form on a website while asking questions or seeking advice from an agent in a text, voice, or audio-video interaction. This is often initiated when a customer is stuck and selects a click-to-call or click-to-chat option. As the customer fills in the form, various back-end processes are executed to monitor the data and progress as the form is being completed.

In addition to various performance metrics, back-end systems may perform data validation. Data validation may be simple, such as to ensure the correct data type (e.g., only allow numbers to be entered into a number field), or more complex. Some of the more complex validations may comprise evaluating options that may have obscure contradictions. While such validations help to reduce errors and provide viable data for subsequent processing, not everything that looks like an error is an error.

### SUMMARY

While a customer is engaged with an agent during a co-browsing session, errors in data entry to the form may be detected. For example, entry of data in the form of “nnn-nn-nnnn,” where “n” is a single digit integer, whether partially or completely entered, may be flagged when the entry is to an address field, due to the appearance of the entry being a social security number (SSN). This may be especially relevant if the proximity to the data entry fields for SSN and address have a history of being confused. Accordingly, the customer may be warned that they are entering an SSN in an address field.

Prior art systems lack a real-time adaptive system to assist the customer, in particular when utilizing multiple channels for the customer to interact with automated and live resources of the contact center.

These and other needs are addressed by the various embodiments and configurations of the present invention. The present invention can provide a number of advantages depending on the particular configuration. These and other advantages will be apparent from the disclosure of the invention(s) contained herein.

Automated systems may give erroneous warnings to the customer. For example, a system may be designed to warn of entries to an address field that take the form of “nnn-nn” (an entry that resembles a partial entry of an SSN). However, the entry may be a genuine address for a specific region or a group of people that has not been previously identified and provided an acceptable pattern. This warning may persist and even prevent further entry into the field, even as the customer talks about the warning with the agent. However, in the prior art, the warnings are static irrespective of the customer reactions and opinions conveyed to the contact center agent.

As an introduction, and in one embodiment, systems and methods are provided to enable a more robust and intelligent machine learning data model that can process and reduce erroneous warnings and improve cross channel agent assistance interactions with customers.

In one embodiment, a controller unit is provided that monitors a customer's ongoing interaction in an omnichannel contact center. Each interaction may utilize a plurality of channels and incorporate voice, video, text, and or text-chat with an agent concurrently with a web form session. The agent may be provided with at least some visibility into the data entered by the customer in the web form. As a result, customer may be in a co-browsing session to fill in a web form and concurrently engaged in a call or chat with an agent. The customer-agent channel may be established prior to the web-form/co-browsing channel. In another embodiment, the customer may have initiated the web page him or herself and, in the process, initiated the communication with the agent, such as by selecting a click-to-dial or click-to-chat option.

In another embodiment, systems and methods are provided that monitor the communication on the interactive channel (e.g., voice or text) between the agent and the customer. Content provided by the customer on the interactive channel is then analyzed to determine the impact on data entries provided in the web-form. In one embodiment, an override to a warning may be provided, such as if the customer says to the agent, “123-45′ really is my address.” As a result, the controller will remove the block/warning on the address field in response to an address that matches a mask for an SSN without requiring any further action or input from either the customer or agent. Conversely, and in another embodiment, if the customer acknowledges the error as a data entry error, such as by saying to the agent, “that's not what I wanted to do,” or similar wording, the fields at issue will be wiped or reset by the controller without requiring any further action or input from either the customer or agent. Additionally or alternatively, the data entered, fully or partially, that initially identified as confidential, such as by matching the pattern for SSN, may be blocked from appearing in the agent's communication device. Upon determining the entry is a valid address, or at least not confidential, the contents of the field may be revealed to the agent on the agent's communication device.

In another embodiment, the customer's input on the agent-customer channel may be utilized to train a neural network or other machine learning aspect of the system, and decrease the number of erroneous warnings and maintain those warnings when appropriate.

In one embodiment, a server is disclosed, comprising: a network interface to a network; and a processor configured with machine-readable instructions maintained in non-transitory memory that, when read by the processor, cause the processor to execute the machine-readable instructions; and wherein the server performs: serve a web form to a customer device and receiving inputs from a customer, via the customer communication device, comprising a first input to a first field of the web form; a first determination comprising determining whether the first input matches a confidential input pattern; upon the first determination being true, cause the web form to issue a warning on the customer communication device; monitor communication content between the customer, utilizing the customer communication device, and an agent utilizing an agent communication device; a second determination, comprising determining whether the communication content comprises indicia of the first determination being erroneous; and upon the second determination being true, cause the web form to retract the warning on the customer communication device.

In another embodiment, a method is disclosed, comprising: serving a web form to a customer device and receiving inputs from a customer, via the customer communication device, comprising a first input to a first field of the web form; making a first determination comprising determining whether the first input matches a confidential input pattern; upon the first determination being true, causing the web form to issue a warning on the customer communication device; monitoring communication content between the customer, utilizing the customer communication device, and an agent utilizing an agent communication device; making a second determination, comprising determining whether the communication content comprises indicia of the first determination being erroneous; and upon the second determination being true, causing the web form to retract the warning on the customer communication device.

In another embodiment, a system is disclosed comprising: means to serve a web form to a customer device and receiving inputs from a customer, via the customer communication device, comprising a first input to a first field of the web form; means to make a first determination comprising determining whether the first input matches a confidential input pattern; means to, upon the first determination being true, cause the web form to issue a warning on the customer communication device; means to monitor communication content between the customer, utilizing the customer communication device, and an agent utilizing an agent communication device; means to make a second determination, comprising determining whether the communication content comprises indicia of the first determination being erroneous; and means to, upon the second determination being true, causing the web form to retract the warning on the customer communication device.

A system on a chip (SoC) including any one or more of the above embodiments or aspects of the embodiments described herein.

One or more means for performing any one or more of the above embodiments or aspects of the embodiments described herein.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above embodiments or aspects, wherein the data storage comprises a non-transitory storage device comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a first system in accordance with embodiments of the present disclosure;

FIG. 2 depicts a second system in accordance with embodiments of the present disclosure;

FIG. 3 depicts a third system in accordance with embodiments of the present disclosure;

FIG. 4 depicts a fourth system in accordance with embodiments of the present disclosure;

FIG. 5 depicts a first process in accordance with embodiments of the present disclosure;

FIG. 6 depicts a second process in accordance with embodiments of the present disclosure; and

FIG. 7 depicts a fifth system in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with a like reference number. When such a reference is made in the singular form, but without identification of the sub-reference identifier, is a reference one of the like numbered elements, but without limitation as to the particular one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

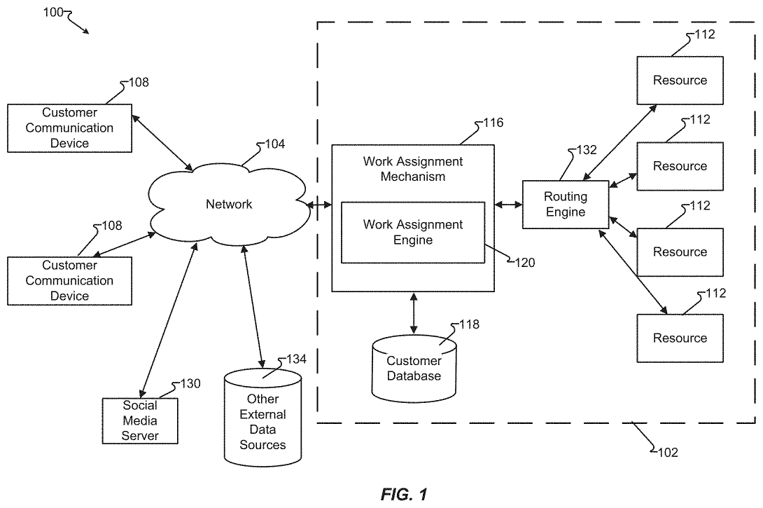

FIG. 1 depicts communication system 100 in accordance with at least some embodiments of the present disclosure. The communication system 100 may be a distributed system and, in some embodiments, comprises a communication network 104 connecting one or more customer communication devices 108 to a work assignment mechanism 116, which may be owned and operated by an enterprise administering contact center 102 in which a plurality of resources 112 is distributed to handle incoming work items (in the form of contacts) from customer communication devices 108.

Contact center 102 is variously embodied to receive and/or send messages that are or are associated with work items and the processing and management (e.g., scheduling, assigning, routing, generating, accounting, receiving, monitoring, reviewing, etc.) of the work items by one or more resources 112. The work items are generally generated and/or received requests for a processing resource 112 embodied as, or a component of, an electronic and/or electromagnetically conveyed message. Contact center 102 may include more or fewer components than illustrated and/or provide more or fewer services than illustrated. The border indicating contact center 102 may be a physical boundary (e.g., a building, campus, etc.), legal boundary (e.g., company, enterprise, etc.), and/or logical boundary (e.g., resources 112 utilized to provide services to customers for a customer of contact center 102).

Furthermore, the border illustrating contact center 102 may be as-illustrated or, in other embodiments, include alterations and/or more and/or fewer components than illustrated. For example, in other embodiments, one or more of resources 112, customer database 118, and/or other component may connect to routing engine 132 via communication network 104, such as when such components connect via a public network (e.g., Internet). In another embodiment, communication network 104 may be a private utilization of, at least in part, a public network (e.g., VPN); a private network located, at least partially, within contact center 102; or a mixture of private and public networks that may be utilized to provide electronic communication of components described herein. Additionally, it should be appreciated that components illustrated as external, such as social media server 130 and/or other external data sources 134 may be within contact center 102 physically and/or logically, but still be considered external for other purposes. For example, contact center 102 may operate social media server 130 (e.g., a website operable to receive user messages from customers and/or resources 112) as one means to interact with customers via their customer communication device 108.

Customer communication devices 108 are embodied as external to contact center 102 as they are under the more direct control of their respective user or customer. However, embodiments may be provided whereby one or more customer communication devices 108 are physically and/or logically located within contact center 102 and are still considered external to contact center 102, such as when a customer utilizes customer communication device 108 at a kiosk and attaches to a private network of contact center 102 (e.g., WiFi connection to a kiosk, etc.), within or controlled by contact center 102.

It should be appreciated that the description of contact center 102 provides at least one embodiment whereby the following embodiments may be more readily understood without limiting such embodiments. Contact center 102 may be further altered, added to, and/or subtracted from without departing from the scope of any embodiment described herein and without limiting the scope of the embodiments or claims, except as expressly provided.

Additionally, contact center 102 may incorporate and/or utilize social media server 130 and/or other external data sources 134 may be utilized to provide one means for a resource 112 to receive and/or retrieve contacts and connect to a customer of a contact center 102. Other external data sources 134 may include data sources, such as service bureaus, third-party data providers (e.g., credit agencies, public and/or private records, etc.). Customers may utilize their respective customer communication device 108 to send/receive communications utilizing social media server 130.

In accordance with at least some embodiments of the present disclosure, the communication network 104 may comprise any type of known communication medium or collection of communication media and may use any type of protocols to transport electronic messages between endpoints. The communication network 104 may include wired and/or wireless communication technologies. The Internet is an example of the communication network 104 that constitutes an Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type and instead may be comprised of a number of different networks and/or network types. As one example, embodiments of the present disclosure may be utilized to increase the efficiency of a grid-based contact center 102. Examples of a grid-based contact center 102 are more fully described in U.S. Patent Publication No. 2010/0296417 to Steiner, the entire contents of which are hereby incorporated herein by reference. Moreover, the communication network 104 may comprise a number of different communication media, such as coaxial cable, copper cable/wire, fiber-optic cable, antennas for transmitting/receiving wireless messages, and combinations thereof.

The customer communication devices 108 may correspond to customer communication devices. In accordance with at least some embodiments of the present disclosure, a customer may utilize their customer communication device 108 to initiate a work item. Illustrative work items include, but are not limited to, a contact directed toward and received at a contact center 102, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication, such as social media server 130. An example of such a harvested communication includes a social media communication that is harvested by the work assignment mechanism 116 from a social media server 130 or network of servers. Exemplary architectures for harvesting social media communications and generating work items based thereon are described in U.S. patent application Ser. Nos. 12/784,369, 12/706,942, and 12/707,277, filed Mar. 20, 2010, Feb. 17, 2010, and Feb. 17, 2010, respectively; each of which is hereby incorporated herein by reference in its entirety.

The format of the work item may depend upon the capabilities of the customer communication device 108 and the format of the communication. In particular, work items are logical representations within a contact center 102 of work to be performed in connection with servicing a communication received at contact center 102 (and, more specifically, the work assignment mechanism 116). The communication may be received and maintained at the work assignment mechanism 116, a switch or server connected to the work assignment mechanism 116, or the like, until a resource 112 is assigned to the work item representing that communication. At which point, the work assignment mechanism 116 passes the work item to a routing engine 132 to connect the customer communication device 108, which initiated the communication, with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the customer communication devices 108 may comprise any type of known communication equipment or collection of communication equipment. Examples of a suitable customer communication device 108 include, but are not limited to, a personal computer, laptop, Personal Digital Assistant (PDA), cellular phone, smart phone, telephone, or combinations thereof. In general, each customer communication device 108 may be adapted to support video, audio, text, and/or data communications with other customer communication devices 108 as well as the processing resources 112. The type of medium used by the customer communication device 108 to communicate with other customer communication devices 108 or processing resources 112 may depend upon the communication applications available on the customer communication device 108.

In accordance with at least some embodiments of the present disclosure, the work item is sent toward a collection of processing resources 112 via the combined efforts of the work assignment mechanism 116 and routing engine 132. The resources 112 can either be completely automated resources (e.g., Interactive Voice Response (IVR) units, microprocessors, servers, or the like), human resources utilizing communication devices (e.g., human agents utilizing a computer, telephone, laptop, etc.), or any other resource known to be used in contact center 102.

As discussed above, the work assignment mechanism 116 and resources 112 may be owned and operated by a common entity in a contact center 102 format. In some embodiments, the work assignment mechanism 116 may be administered by multiple enterprises, each of which has its own dedicated resources 112 connected to the work assignment mechanism 116.

In some embodiments, the work assignment mechanism 116 comprises a work assignment engine 120, which enables the work assignment mechanism 116 to make intelligent routing decisions for work items. In some embodiments, the work assignment engine 120 is configured to administer and make work assignment decisions in a queueless contact center 102, as is described in U.S. patent application Ser. No. 12/882,950, the entire contents of which are hereby incorporated herein by reference. In other embodiments, the work assignment engine 120 may be configured to execute work assignment decisions in a traditional queue-based (or skill-based) contact center 102.

The work assignment engine 120 and its various components may reside in the work assignment mechanism 116 or in a number of different servers or processing devices. In some embodiments, cloud-based computing architectures can be employed whereby one or more hardware components of the work assignment mechanism 116 are made available in a cloud or network such that they can be shared resources among a plurality of different users. Work assignment mechanism 116 may access customer database 118, such as to retrieve records, profiles, purchase history, previous work items, and/or other aspects of a customer known to contact center 102. Customer database 118 may be updated in response to a work item and/or input from resource 112 processing the work item.

It should be appreciated that one or more components of contact center 102 may be implemented in a cloud-based architecture in their entirety, or components thereof (e.g., hybrid), in addition to embodiments being entirely on-premises. In one embodiment, customer communication device 108 is connected to one of resources 112 via components entirely hosted by a cloud-based service provider, wherein processing and data storage hardware components may be dedicated to the operator of contact center 102 or shared or distributed amongst a plurality of service provider customers, one being contact center 102.

In one embodiment, a message is generated by customer communication device 108 and received, via communication network 104, at work assignment mechanism 116. The message received by a contact center 102, such as at the work assignment mechanism 116, is generally, and herein, referred to as a “contact.” Routing engine 132 routes the contact to at least one of resources 112 for processing.

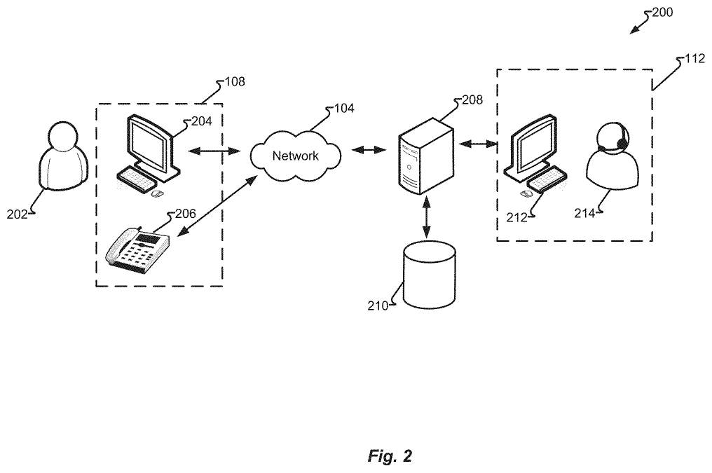

FIG. 2 depicts system 200 in accordance with embodiments of the present disclosure. In one embodiment, system 200 illustrates portions of system 100 with additions thereto. In one embodiment, system 200 illustrates customer 202 utilizing customer communication device 108 to communicate with resource 112 in a co-browsing session, such as to complete a web form or perform other operation on customer communication device 108. Customer communication device 108 may be embodied as a single device operable to communicate using two or more media and associated channels. For example, customer communication device 108 may be embodied as customer communication device 204 (e.g., a personal computer, smart phone, or other multi-channel communication device) and communicate using voice, video, and/or text, such as with agent 214, in addition to simultaneously interacting with a web form or other website to receive and/or provide inputs thereto, such as may be served from server 208.

Customer communication device 108 may be embodied as a plurality of devices, such as customer communication device 204, communicating on a data channel with server 208, and a discrete device, such as customer communication device 206. Customer communication device 206 may be an audio only telephone, audio-video endpoint, text-based communication device, or a discrete multi-channel device). The association of the communication utilizing customer communication device 204 and customer communication device 206 may be initiated by customer 202, such as when completing a web form on customer communication device 204 and selecting a “call me” option and providing the number for customer communication device 206 or calling server 208, and being routed to resource 112, and providing an indicia of the session utilizing customer communication device 204. In other embodiments, the call to customer communication device 206 may be initiated from server 208 and/or agent communication device 212, such as upon server 208 determining that a pattern of errors has occurred during the attempt to complete the web form on customer communication device 204 by customer 202 and proactively offering assistance based on a known telephone number for customer communication device 206.

Resource 112 may be embodied as agent 214 utilizing agent communication device 212 to communicate with customer 202 via one or more communication channels (e.g., text, voice, video, co-browsing). Accordingly, resource 112 may utilize agent communication device 212 comprising a display, microphone, speaker, keyboard, and/or other input-output device for use by agent 214. In another embodiment, resource 112 may be a fully automated resource, such as to playback a co-browsing script that has been, in whole or in part, been previously recorded and/or generated to assist customer 202 in resolving their issue. Therefore, resource 112, in certain embodiments, may be incorporated into server 208.

Server 208 may be embodied as a single device or a plurality (e.g., server farm, array, “cloud”, blades, etc.) and perform one or more functions. In one embodiment, server 208 comprises a web server to present customer communication device 204 with a web form and receive information input to the web form by customer 202. The web form and/or data received may be maintained in records of data storage 210. Data storage 210 may be a single device or a plurality (e.g., storage array, storage as a service, “cloud,” etc.). Server 208 and/or data storage 210 may incorporate, or be incorporated into, other hardware, such as work assignment mechanism 116, work assignment engine 120, routing engine 132, customer database 118, etc. Additionally or alternatively, server 208 may provide networking functionality, such as to manage one or more channels of communication from customer communication device 108, associate multiple channels with the same customer 202, manage connections (e.g., Session Initiation Protocol (SIP) session management, connectivity to cellular network, connectivity to a plain old telephone system (POTS), etc.), network connection to network 104 (e.g., Internet, telephony, etc.).

In another embodiment, server 208 provides a web form to customer communication device 204 and monitors a communication between customer 202, utilizing customer communication device 108, and resource 112, such as agent 214 utilizing agent communication device 212. When the communication between customer 202 and resource 112 comprises text, server 208 analyzes the text to determine the content therein. When the communication between customer 202 and resource 112 comprises spoken content (e.g., encoded audio signals), server 208 may first perform a speech-to-text conversion before determining the content therein.

In another embodiment, server 208 may perform “back-end” processing on the data entered into the web form. This processing may be done with an aggregation of data input to a number of fields of the web form, an input to a single field, and/or character-by-character. Additionally or alternatively, server 208 may selectively provide or conceal data entered into the web form from viewing by resource 112 when embodied as agent 214 utilizing agent communication device 212. For example, certain data input into the web field may be known to be confidential (e.g., social security number, bank account numbers, credit card number, etc.) and to avoid unnecessarily exposing the confidential information, the data input into a field known to collect confidential information may be obscured. For example, substituting entries with an “x” or merely indicating the state of the field (e.g., no data has been entered, some data has been entered, the data has been completely entered, the data entered is valid, the data entered is not valid, etc.). However, customers, such as customer 202 may erroneously enter data in the wrong field. This may be due a misconception of which field has focus, especially if some data has been prepopulated. As a result, customer 202 may mistakenly enter confidential information, such as a social security number, in a field not designated for confidential information, such as an address field. Accordingly, server 208 may pattern-match the data entered and determine the data is confidential from the pattern, such as “nnn-”, “nnn-n”, “nnn-nn”, “nnn-nn-”, “nnn-nn-n”, “nnn-nn-nn”, “nnn-nn-nnn”, or “nnn-nn-nnnn”, where “n” is a single digit and, with the number and placement of the digits interspersed with hyphen(s) at specific locations, the entry may be determined to be confidential (e.g., all or a portion of a social security number) and blocked. Other patterns may comprise other mixes of character types, such as to match an account number or other confidential information. However, this may be the result of error on the part of server 208 and the entry is a legitimate address or other non-confidential information appropriate for the target field of the web form.

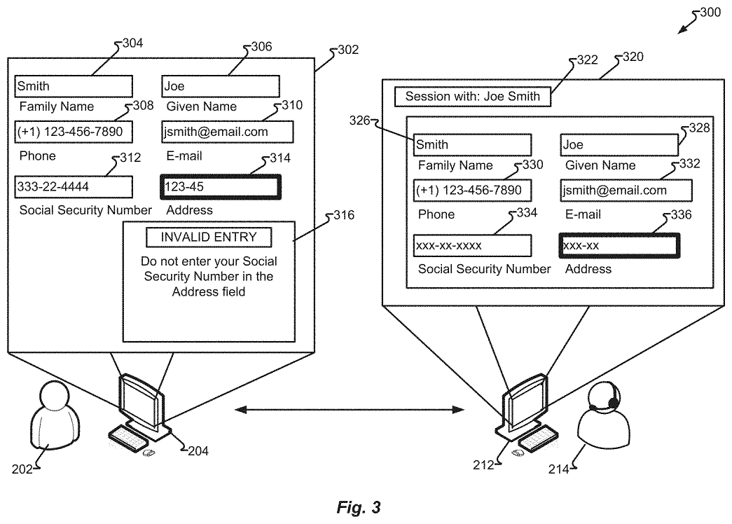

FIG. 3 depicts system 300 in accordance with embodiments of the present disclosure. In one embodiment, system 300 illustrates portions of system 200 and system 100, but omits certain features to avoid unnecessarily complicating the figure with elements described elsewhere. In one embodiment, customer 202 is engaged in completing web form 302. Web form 302 comprises a number of non-confidential fields (e.g., family name field 304, given name field 306, phone field 308, email field 310, address field 314) and a confidential field (e.g., social security number field 312).

During a co-browsing session with agent 214, web form image 320 may be presented on agent communication device 212 for session identifier 322. The presentation of web form image 320 may be in read-only mode, where inputs are provided by customer 202 and agent communication device 212 only presents information and cannot receive any inputs from agent communication device 212 to the web form. Alternatively, web form image 320 may be read-write mode, where agent 214 may provide certain inputs to web form 302 as presented as web form image 320. Content provided by customer 202 that is not confidential may be presented as-entered, such as by family name image 326, given name image 328, phone image 330, email image 332. Data entered into social security number field 312, a field designated for confidential information, may always be presented as obscured in social security number image 334, regardless of the content. However, server 208 may determine that the entry to address field 314, a designated non-confidential field, matches a pattern for confidential information and provides address image 336 as obscured. Had the entry to address field 314 not matched the pattern for confidential information (e.g., social security number), address image 336 may then display the information as entered.

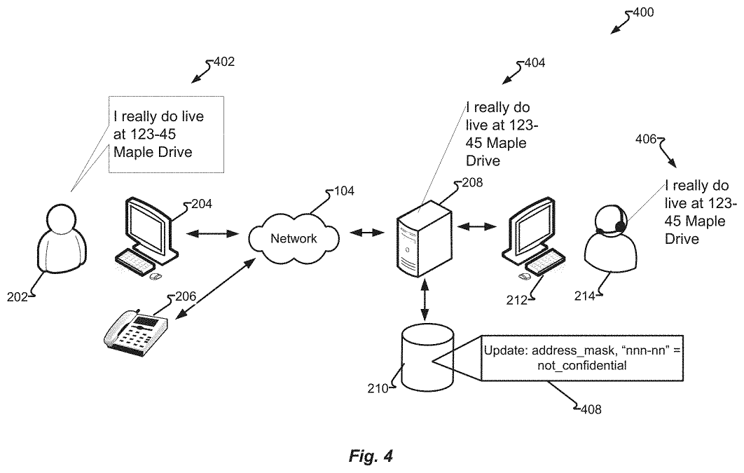

In another embodiment, warning 316 is provided to customer communication device 204. Warning 316 may allow continued entry or block any further entry, other than to delete content previously entered. As a result of warning 316 customer 202 may be engaged in a second channel (e.g., voice, text) to discuss warning 316 and the resolution thereof in order to complete web form 302, as described more completely with respect to FIG. 4. While the entry of data into address field 314 is illustrated as being initially determined to be confidential, but later indicated by customer 202 to not be confidential. It should be appreciated that any data validation operation may be utilized and cause a warning or other indication that the web form cannot be completed based on the information entered. For example, validation may perform a check of an address with a post office or similar entity and determine that an entry is invalid. However, it is possible that the address is valid, but is a new built that has not yet been recorded by the post office's address validation service. Accordingly, a non-confidential but erroneous invalid address may result in a warning similar to warning 316 or otherwise cause the web form to be invalid and unable to be successfully completed unless resolved, such as by customer 202 identifying the address as valid. As a further option, warning 316 may be the result of an entry, or partial entry to a single field, such as address field 314. In other embodiments, validation may comprise data entered in two or more fields. For example, phone field 308 may comprise a valid data entry for a United States telephone number, but an invalid entry if the known country (input elsewhere) utilizes a different format for telephone numbers. In another embodiment, validation may be based on business rules or other more complex logic. For example, an airline may present a web form to book travel and, while each individual field comprises accurate and compliant content, the combination is invalid—such as when a customer attempts to schedule a flight departing from a location they are not scheduled to be at. However, the business rules may erroneously trigger a warning and block completion of the web form. For example, the traveler may have found flights to be cheaper to include the conflicting leg, and not using it, and taking a train to the next location where they are able to make the requested departing flight.

FIG. 4 depicts system 400 in accordance with embodiments of the present disclosure. In one embodiment, system 400 illustrates an interaction between customer 202, utilizing customer communication device 206, and agent 214, utilizing agent communication device 212, to resolve an issue with a web form. However, it should be appreciated that other topologies, devices, and forms of communication may be utilized to facilitate the communication between customer 202 and agent 214, over network 104, without departing from the scope of the embodiments herein.

In one embodiment, customer 202 is utilizing customer communication device 204 to complete a web form (e.g., web form 302) but is unable to complete the form due to a warning (e.g., warning 316). While engaged in the communication with agent 214, customer 202 speaks user provided communication content 402, such as by speech converted to audio signals by customer communication device 206 to be conveyed over network 104. User provided communication content 402 is received as intercepted content 404 by server 208 and analyzed while delivered content 406 is presented to agent 214, such as by decoding audio signals into sound waves.

Intercepted content 404 analyzes intercepted content 404 and determines that reference is being made to rationale that caused server 208 to trigger warning 316. As a result of user provided communication content 402 being provided as delivered content 406 to agent 214, server 208 automatically determines that what was initially determined to be confidential information due to the entry matching a pattern of confidential information, is a legitimate entry. As a result, server 208 may cause logic rule update 408 to update a local rule maintained in data storage 210 and/or other location. Additionally or alternatively, the block may be automatically removed, such as by server 208 updating web form 302 to exclude warning 316, allow further entry to address field 314, and/or un-obscure address image 336, without human intervention.

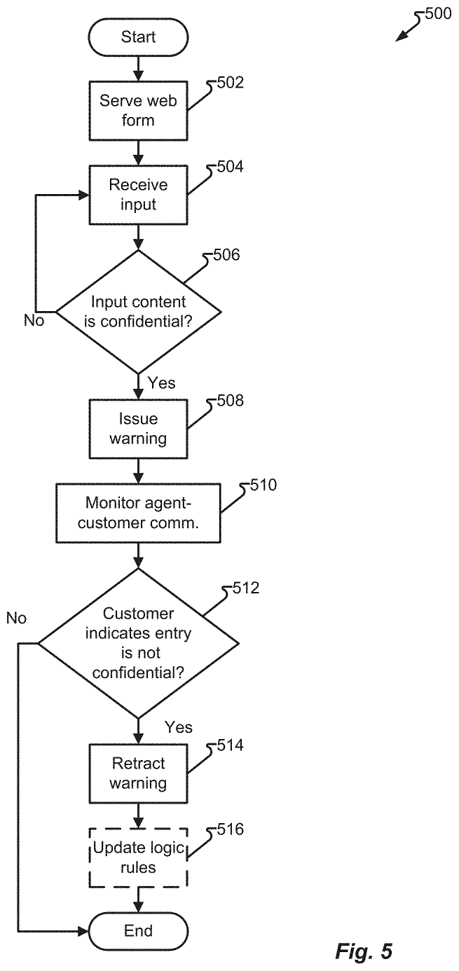

FIG. 5 depicts process 500 in accordance with embodiments of the present disclosure. In one embodiment, process 500 is embodied as machine-readable instructions maintained in a non-transitory data storage that, when read by a processor such as a processor of server 208, cause the processor to perform the steps of process 500. In one embodiment, process 500 self corrects an erroneous decision to block content provided on a web form due to faulty logic identified by customer 202 in a communication channel, which is different from the communication channel utilized for the web form, to communicate with resource 112, such as agent 214 utilizing agent communication device 212, which may further comprise text and/or voice-based communications.

Process 500 begins and, in step 502, a web form is served, such as by server 208 to customer communication device 204. Step 504 receives an input to the web form and determines, in test 506 if the input is confidential. If test 506 is determined in the negative, process 500 may loop back to step 504 to receive a next input. The loop may end and process 500 terminated upon completion of all portions of the web form. If test 506 is determined in the affirmative, step 508 issues a warning, such as warning 316. Additionally or alternatively, step 508 may block further entry to the subject field (other than entries to remove the content previously provided), highlight the subject field, block agent 214 from being presented the content of the subject field during a co-browsing session, and/or other operation consistent with confidential information being received.

Step 510 then monitors a communication between the customer completing the web form (e.g., customer 202) and an agent (e.g., resource 112, when embodied as an automated resource, and/or agent 214, when embodied as a live agent utilizing agent communication device 212). Test 512 determines if the customer provided communication includes an indication that the information entered, and determined to be confidential, is not confidential. If test 512 is determined in the negative, the block may remain and process 500 ended or loop back to step 504 (not shown) for a next field. However, if test 512 is determined in the affirmative, processing continues to step 514 wherein the warning is retracted, such as to allow the field to maintain the value entered or receive additional entries. Optionally step 516 updates the logic rules that caused test 506 to be determined in the affirmative.

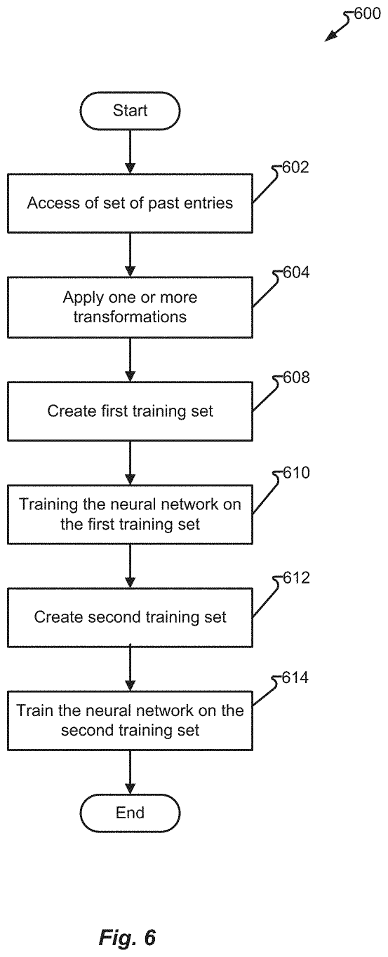

FIG. 6 depicts process 600 in accordance with embodiments of the present disclosure. In one embodiment, process 600 is embodied as machine-readable instructions maintained in a non-transitory data storage that, when read by a processor such as a processor of server 208, cause the processor to perform the steps of process 600.

Process 600 illustrates the training of a neural network, such as to enable server 208 to make a determination of whether or not an entry to a field, which may be a complete entry or a portion thereof, is confidential or otherwise erroneous and prevent a field or web form from being completed satisfactorily. A neural network, as is known in the art and in one embodiment, self-configures layers of logical nodes having an input and an output. If an output is below a self-determined threshold level, the output is omitted (i.e., the inputs are within the inactive response portion of a scale and provide no output), if the self-determined threshold level is above the threshold, an output is provided (i.e., the inputs are within the active response portion of a scale and provide an output), the particular placement of the active and inactive delineation is provided as a training step or steps. Multiple inputs into a node produce a multi-dimensional plane (e.g., hyperplane) to delineate a combination of inputs that are active or inactive.

In step 602, a set of past entries is accessed. The past entries may comprise data matching a particular pattern, but varying in the field receiving the entries, data type, pattern, format, etc. Step 604 applies one or more transformations to the set of past entries. The transformations include one or more of altering a field receiving the past data entry, adding punctuation, removing punctuation, adding whitespace, removing whitespace, concatenating additional characters, truncating characters, and substituting a digit with a different digit.

Next, step 608 creates a first training set to comprise the past data entries, the modified set of data entries, and a set of non-confidential (or non-erroneous) data entries. Step 610 then trains the neural network on the first set of training data. A second set of training data is created in step 612, comprising the first set of training data and the non-confidential (or non-erroneous) data entries that were initially indicated as being confidential in a non-confidential field (or otherwise erroneous) after training the neural network with the first training set. Then, in step 614, the neural network is trained with the second training set.

In another embodiment, the neural network, once trained, is provided by a server, such as server 208, validating entries to a web from and receiving from the neural network, an indication of whether the entries, or a combination of entries, is an erroneous entry. Should server 208 receive a determination that is found to be in error, such as to mistakenly conclude that confidential information has been entered into a field designated for non-confidential information, such as described elsewhere herein, the neural network may be provided with indicia of the error to further correct and improve the accuracy of the decisions made by server 208 and the neural network. For example, a particular address may appear to be invalid but associated information (e.g., the city, postal code, etc.) may indicate that such addresses may be expected and are valid for such a location, and yet remain invalid elsewhere.

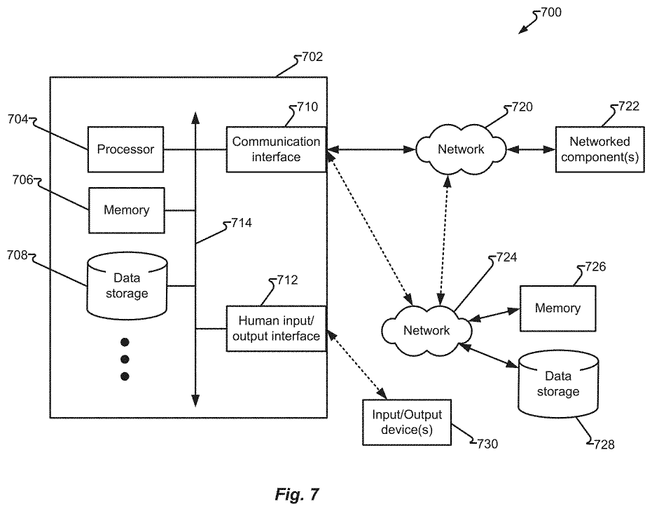

FIG. 7 depicts device 702 in system 700 in accordance with embodiments of the present disclosure. In one embodiment, server 208 may be embodied, in whole or in part, as device 702 comprising various components and connections to other components and/or systems. The components are variously embodied and may comprise processor 704. The term “processor,” as used herein, refers exclusively to electronic hardware components comprising electrical circuitry with connections (e.g., pin-outs) to convey encoded electrical signals to and from the electrical circuitry. Processor 704 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 714, executes instructions, and outputs data, again such as via bus 714. In other embodiments, processor 704 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 704 is a non-transitory computing device (e.g., electronic machine comprising circuitry and connections to communicate with other components and devices).

Processor 704 may operate a virtual processor, such as to process machine instructions not native to the processor (e.g., translate the VAX operating system and VAX machine instruction code set into Intel® 9xx chipset code to allow VAX-specific applications to execute on a virtual VAX processor), however, as those of ordinary skill understand, such virtual processors are applications executed by hardware, more specifically, the underlying electrical circuitry and other hardware of the processor (e.g., processor 704). Processor 704 may be executed by virtual processors, such as when applications (i.e., Pod) are orchestrated by Kubernetes. Virtual processors allow an application to be presented with what appears to be a static and/or dedicated processor executing the instructions of the application, while underlying non-virtual processor(s) are executing the instructions and may be dynamic and/or split among a number of processors.

In addition to the components of processor 704, device 702 may utilize memory 706 and/or data storage 708 for the storage of accessible data, such as instructions, values, etc. Communication interface 710 facilitates communication with components, such as processor 704 via bus 714 with components not accessible via bus 714. Communication interface 710 may be embodied as a network port, card, cable, or other configured hardware device. Additionally or alternatively, human input/output interface 712 connects to one or more interface components to receive and/or present information (e.g., instructions, data, values, etc.) to and/or from a human and/or electronic device. Examples of input/output devices 730 that may be connected to input/output interface include, but are not limited to, keyboard, mouse, trackball, printers, displays, sensor, switch, relay, speaker, microphone, still and/or video camera, etc. In another embodiment, communication interface 710 may comprise, or be comprised by, human input/output interface 712. Communication interface 710 may be configured to communicate directly with a networked component or utilize one or more networks, such as network 720 and/or network 724.

Network 104 may be embodied, in whole or in part, as network 720. Network 720 may be a wired network (e.g., Ethernet), wireless (e.g., WiFi, Bluetooth, cellular, etc.) network, or combination thereof and enable device 702 to communicate with networked component(s) 722. In other embodiments, network 720 may be embodied, in whole or in part, as a telephony network (e.g., public switched telephone network (PSTN), private branch exchange (PBX), cellular telephony network, etc.)

Additionally or alternatively, one or more other networks may be utilized. For example, network 724 may represent a second network, which may facilitate communication with components utilized by device 702. For example, network 724 may be an internal network to a business entity or other organization, such as contact center 102, whereby components are trusted (or at least more so) that networked components 722, which may be connected to network 720 comprising a public network (e.g., Internet) that may not be as trusted.

Components attached to network 724 may include memory 726, data storage 728, input/output device(s) 730, and/or other components that may be accessible to processor 704. For example, memory 726 and/or data storage 728 may supplement or supplant memory 706 and/or data storage 708 entirely or for a particular task or purpose. For example, memory 726 and/or data storage 728 may be an external data repository (e.g., server farm, array, “cloud,” etc.) and allow device 702, and/or other devices, to access data thereon. Similarly, input/output device(s) 730 may be accessed by processor 704 via human input/output interface 712 and/or via communication interface 710 either directly, via network 724, via network 720 alone (not shown), or via networks 724 and 720. Each of memory 706, data storage 708, memory 726, data storage 728 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 730 may be a router, switch, port, or other communication component such that a particular output of processor 704 enables (or disables) input/output device 730, which may be associated with network 720 and/or network 724, to allow (or disallow) communications between two or more nodes on network 720 and/or network 724. For example, a connection between one particular customer, using a particular customer communication device 108, may be enabled (or disabled) with a particular networked component 722 and/or particular resource 112. Similarly, one particular networked component 722 and/or resource 112 may be enabled (or disabled) from communicating with a particular other networked component 722 and/or resource 112, including, in certain embodiments, device 702 or vice versa. One of ordinary skill in the art will appreciate that other communication equipment may be utilized, in addition or as an alternative, to those described herein without departing from the scope of the embodiments.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally or alternative, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARIVI926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A server, comprising:
a network interface to a network; and
a processor configured with machine-readable instructions maintained in non-transitory memory that, when read by the processor, cause the processor to execute the machine-readable instructions; and
wherein the server performs:
serve a web form to a customer device and receiving inputs from a customer, via the customer communication device, comprising a first input to a first field of the web form;
a first determination comprising determining whether the first input matches a confidential input pattern;
upon the first determination being true, cause the web form to issue a warning on the customer communication device;
monitor communication content between the customer, utilizing the customer communication device, and an agent utilizing an agent communication device;
a second determination, comprising determining whether the communication content comprises indicia of the first determination being erroneous; and
upon the second determination being true, cause the web form to retract the warning on the customer communication device.

2. The server of claim 1, wherein the server causes the web form to issue the warning further comprising disallowing any subsequent entry to the first field.

3. The server of claim 1, further performing:
provide an image of the web form to the agent communication device; and
upon the first determination being true, further causing the image of the web form to omit presentation of the first input to the first field.

4. The server of claim 3, further performing:
upon the second determination being true, causing the image of the web form to present the first input to the first field.

5. The server of claim 1, wherein the server makes the first determination comprising providing the first input to a neural network trained to determine confidential inputs and receiving a decision therefrom.

6. The server of claim 5, further comprising:
wherein the web form further comprising a second input to a second field of the web form; and
wherein the server further provides the second input to neural network trained to determine confidential inputs to at least one of the first field or second field from the combination of the first input and second input.

7. The server of claim 5, wherein the neural network is trained to make the first determination, comprising:
accessing a set of past data entries to the web form;
applying one or more transformations to each past data entry of the set of past data entries including one or more of altering a field receiving the past data entry, adding punctuation, removing punctuation, adding whitespace, removing whitespace, concatenating additional characters, truncating characters, and substituting a digit with a different digit to create a modified set of past data entries;
creating a first training set comprising the set of past data entries, the modified set of data entries, and a set of non-confidential data entries;
training the neural network in a first state using the first training set;
creating a second training set for a second state of training comprising the first training set and the set of non-confidential data entries that are incorrectly identified as being confidential; and
training the neural network in the second state using the second training set.

8. The sever of claim 7, further comprising subsequent training of the neural network, comprising:
creating a third training set for a third state of training comprising the first field entry when the second determination is true; and
training the neural network in the third state using the third training set.

9. The server of claim 1, wherein communication content between the customer and the agent comprises a number of textual messages.

10. The server of claim 1, wherein communication content between the customer and the agent comprises spoken content.

11. A method, comprising:
serving a web form to a customer device and receiving inputs from a customer, via the customer communication device, comprising a first input to a first field of the web form;
making a first determination comprising determining whether the first input matches a confidential input pattern;
upon the first determination being true, causing the web form to issue a warning on the customer communication device;
monitoring communication content between the customer, utilizing the customer communication device, and an agent utilizing an agent communication device;
making a second determination, comprising determining whether the communication content comprises indicia of the first determination being erroneous; and
upon the second determination being true, causing the web form to retract the warning on the customer communication device.

12. The method of claim 11, wherein the server causes the web form to issue the warning further comprising disallowing any subsequent entry to the first field.

13. The method of claim 11, further comprising:
providing an image of the web form to the agent communication device; and
upon the first determination being true, further causing the image of the web form to omit presentation of the first input to the first field.

14. The method of claim 13, further comprising, upon the second determination being true, causing the image of the web form to present the first input to the first field.

15. The method of claim 11, wherein the first determination comprising providing the first input to a neural network trained to determine confidential inputs and receiving a decision therefrom.

16. The method of claim 15, further comprising:
wherein the web form further comprising a second input to a second field of the web form; and
providing the input to the neural network further comprises providing the second input to neural network trained to determine confidential inputs to at least one of the first field or second field from the combination of the first input and second input.

17. The method of claim 15, wherein the neural network is trained to make the first determination, comprising:
accessing a set of past data entries to the web form;
applying one or more transformations to each past data entry of the set of past data entries including one or more of altering a field receiving the past data entry, adding punctuation, removing punctuation, adding whitespace, removing whitespace, concatenating additional characters, truncating characters, and substituting a digit with a different digit to create a modified set of past data entries;
creating a first training set comprising the set of past data entries, the modified set of data entries, and a set of non-confidential data entries;
training the neural network in a first state using the first training set;
creating a second training set for a second state of training comprising the first training set and the set of non-confidential data entries that are incorrectly identified as being confidential; and
training the neural network in the second state using the second training set.

18. The method of claim 17, further comprising subsequent training of the neural network, comprising:
creating a third training set for a third state of training comprising the first field entry when the second determination is true; and
training the neural network in the third state using the third training set.

19. The method of claim 11, wherein communication content between the customer and the agent comprises one of a number of textual messages or spoken content.

20. A system, comprising:
means to serve a web form to a customer device and receiving inputs from a customer, via the customer communication device, comprising a first input to a first field of the web form;
means to make a first determination comprising determining whether the first input matches a confidential input pattern;
means to, upon the first determination being true, cause the web form to issue a warning on the customer communication device;
means to monitor communication content between the customer, utilizing the customer communication device, and an agent utilizing an agent communication device;
means to make a second determination, comprising determining whether the communication content comprises indicia of the first determination being erroneous; and
means to, upon the second determination being true, causing the web form to retract the warning on the customer communication device.
